(19) United States
(12) Patent Application Publication
(10) Pub. No.: US 2005/0099447 A1
(43) Pub. Date: May 12, 2005

(54) Method and apparatus for detecting faulty nozzles

(76) Inventors: Juei Tsang Hsu, Hsinchu (TW); Jessen Chen, Hsinchu (TW); Jane Chang, Hsinchu (TW); Yu-Chu Huang, Hsinchu (TW)

Correspondence Address: BIRCH STEWART KOLASCH & BIRCH, PO BOX 747, FALLS CHURCH, VA, 22040-0747, US

(21) Appl. No.: 10/786,035

(22) Filed: Feb. 26, 2004

(30) Foreign Application Priority Data
Nov. 11, 2003 (TW) 092131586

(51) Int. Cl. B41J 29/393

(52) U.S. Cl. 347/19

(57) ABSTRACT

A method and apparatus for detecting faulty nozzles is applied to a multi-function peripheral (MFP). The method is to print a predefined test pattern by an inkjet component of a printing unit. A scanning unit connecting with the printing unit scans the predefined test pattern to generate an image data of the predefined test pattern. Afterwards, an analyzing unit analyzes the image data of the predefined test pattern to see if any one of the nozzles is clogged. Finally, the analyzing unit reports the result to the printing unit. The printing unit will avoid using the clogged nozzles during the printing process to improve the quality of printing.

### BACKGROUND OF THE INVENTION

1. Field of Invention

The invention pertains to a method and apparatus for detecting faulty nozzles. In particular, it relates to an inkjet printer for multi-function peripherals (MFP) and with printing and scanning functions. It also relates to an apparatus and method that use connected scanner and inkjet printer to detect faulty nozzles in the inkjet component.

2. Related Art

An inkjet multi-function printer with printing and scanning functions can be used to scan or print images and documents. The image scanning part uses an image sensor (such as CCD or CIS) in the optical scanning apparatus to scan an image or document, obtaining a raw image data. The raw image data are stored in memory.

To print the image data, the apparatus performs appropriate image and half-tone processes and makes the inkjet print head to move back and forth on a medium (such as paper). The nozzles on the inkjet print head are driven to eject ink droplets at desired positions on the medium, printing the image.

Nowadays, to achieve the photographic quality, the inkjet MFP has to ensure that all nozzles on the print head are functioning correctly. However, the nozzles on the print head may be clogged due to the shortage of ink or burned out heaters. In such cases, the nozzles are damaged and cannot function normally. Correspondingly, the pixel locations corresponding to the faulty on paper are blank or light in color. These are the commonly seen bandings.

However, if there are too many or large bandings in a document, the scanned or faxed document may become useless. One has to replace the print head before printing or faxing again. This results in resource wastes.

To solve the problems, the U.S. Pat. No. 6,215,557 discloses a method for detecting faulty nozzles on the print head of an inkjet printer. It uses the printer to print a test pattern. The test pattern is comprised of a series of blocks, each of which has a position corresponding to a distinct nozzle.

Afterwards, the method uses a personal computer to display the same test pattern on a terminal using the user interface (UI) of a printer driver. If the printed test pattern has some blank block, it means that the nozzle corresponding to block is out of order. In this case, the user uses the mouse to click the blank area on the screen to record the disordered nozzle. Thus, the printer driver records the positions of the faulty nozzles in a mask. Using the mask, the method can avoid using the faulty nozzles to print. For users, however, the clicking process is complicated, time consuming and may result in errors.

Moreover, the method of detecting whether nozzles in an inkjet printer are clogged or out of order disclosed in the U.S. Pat. No. 6,352,331 adds a set of optical scanning apparatus on the side of the print head carrier. When performing the calibration before printing, the printer first prints a test pattern on paper. The optical scanner detects the test pattern (as a beam will be reflected from the test pattern once it is emitted from the optical scanner). Afterwards, the method uses the reflected signal received from the optical scanner to determine whether any nozzle is clogged or damaged. In such case, an optical apparatus has to be installed besides the carriage. This may be redundant and costly especially in MFP.

### SUMMARY OF THE INVENTION

In view of the foregoing, an objective of the invention is to provide an apparatus and method for detecting faulty nozzles. The invention can be used in multi-function peripherals (MFP), inkjet printers with printing and scanning functions, or modules of a scanner and an inkjet printer connected by wire or wireless. Through the steps of printing, scanning, and analyzing, the method can detect which nozzles in the inkjet component are clogged or damaged. Finally, the analyzed results are used to establish a mask containing the faulty nozzles. The mask is utilized in subsequent printing jobs to use normal nozzles to compensate for the faulty nozzles. Therefore, the invention can avoid bandings in the printed documents, rending a higher quality of printing.

The disclosed apparatus mainly contains a printing unit, a scanning unit, a memory unit, and an analyzing unit.

First, the inkjet component of the printing unit prints a predefined test pattern. The inkjet component comprises of multiple arrayed nozzles. The predefined test pattern constitutes of many small blocks, each of which corresponds to a distinct nozzle in the printing unit.

The printed predefined test pattern is sent to the scanning unit for scanning. An image of the printed predefined test pattern is thus generated.

The image data are stored in the memory unit. The analyzing unit analyzes the image data of the predefined test pattern. If there is any nozzle clogged or damaged in the ink-jet component, the corresponding block is blank.

Finally, the analyzing module sends the result back to the printing unit so that it will avoid using the faulty nozzle in future printing. The quality of printing can thus be enhanced.

### BRIEF DESCRIPTION OF THE DRAWINGS

The invention will become more fully understood from the detailed description given hereinbelow illustration only, and thus are not limitative of the present invention, and wherein:

FIG. 1 shows a system structure of the disclosed apparatus for detecting faulty nozzles;

FIG. 2 is a three-dimensional view of a MFP;

FIG. 3 is a schematic view of printing the predefined test pattern in the monochromatic mode;

FIG. 4 is a schematic view of printing the predefined test pattern in the color mode;

FIG. 5 is a schematic view of blank blocks when some nozzles cannot print normally; and

FIG. 6 is a flowchart of the disclosed method for detecting faulty nozzles.

### DETAILED DESCRIPTION OF THE INVENTION

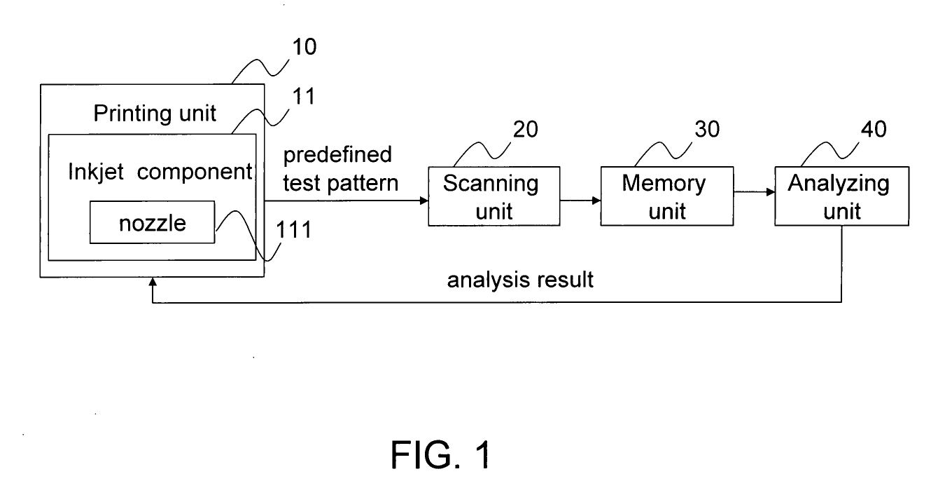

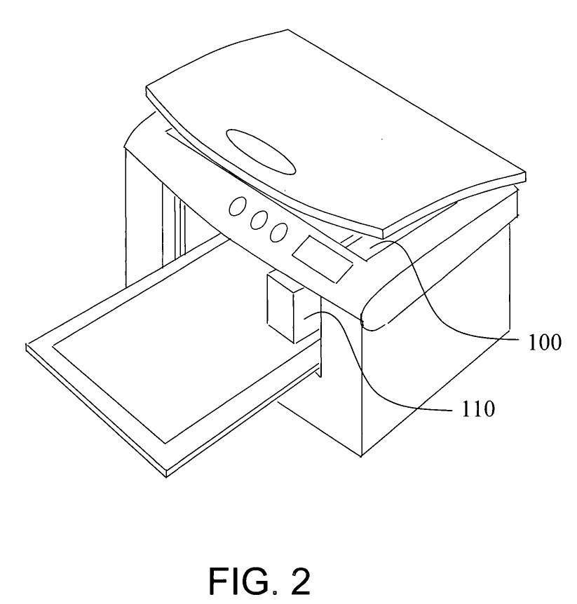

The system structure of the disclosed apparatus for detecting faulty nozzles is shown in FIG. 1. It can be applied to the multi-function peripheral (MFP) shown in FIG. 2. The MFP contains an image scanning apparatus 100 for scanning documents and an inkjet print head 110 for printing. The invention can detect whether any nozzle on the ink-jet component (i.e. the print head 110) is damaged or clogged.

Of course, the applications of the invention are not limited to the MFP. It can also be applied to inkjet printers including printing and scanning functions or a module of a scanner and an inkjet printer connected by wire or wireless together with proper applications software.

The apparatus has the following main parts: a printing unit 10, a scanning unit 20, a memory unit 30, and an analyzing unit 40.

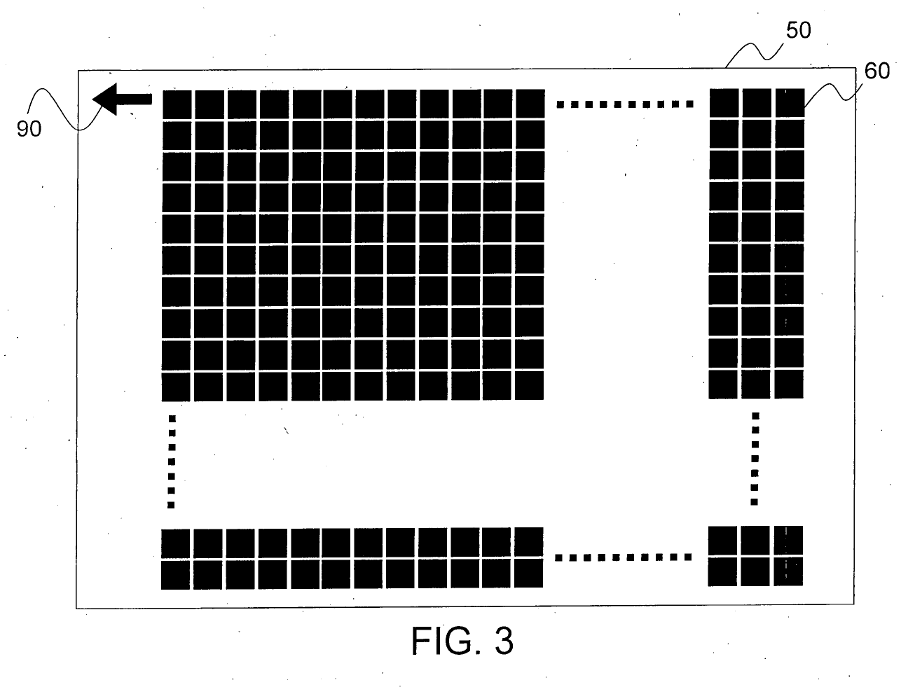

The printing unit 10 contains an inkjet component 11 with multiple arrayed nozzles 111. Its function is equivalent to an inkjet printer. As shown in FIG. 3, the ink-jet component 11 is driven to move back and forth when testing the faulty nozzles 111 therein. Different nozzles 111 are driven to print a predefined test pattern in corresponding areas on a printing medium 50 (such as paper). As shown in the drawing, the predefined test pattern is comprised of several blocks 60. Similar rectangular blocks 60 exist in both horizontal and vertical directions. Each block 60 corresponds to different locations of the nozzles 111 (that is, each small block 60 represents a nozzle 111).

For a monochromatic printing unit 10, each printed block 60 in the predefined test pattern is black. For a color printing unit 10, the predefined test pattern has several sets of differently colored blocks 60 corresponding to the nozzles 111.

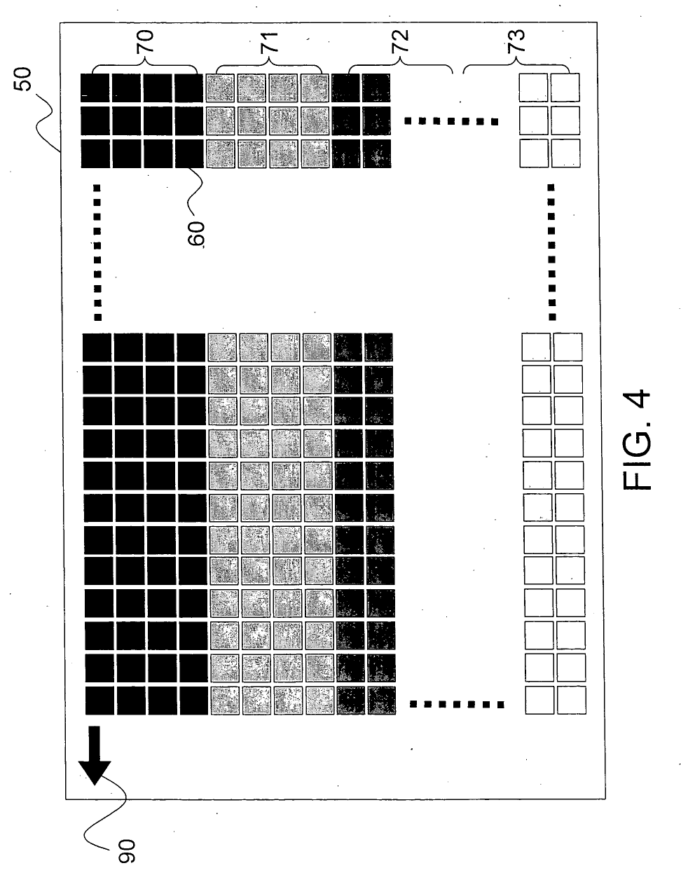

Take the printing unit 10 with four different colors (cyan, magenta, yellow, and black) as an example. As shown in FIG. 4, the predefined test pattern has four sets of differently colored areas corresponding to the four colors. Each block 60 in the area 70 is black; each block 60 in the area 71 is cyan; each block 60 in the area 72 is magenta; and each block 60 in the area 73 is yellow. FIG. 4 is only one example of many embodiments. Whether it is a monochromatic or color printing unit, the block size and order of the test pattern only need to satisfy the principle that each block corresponds to a distinct nozzle. The blocks in according to the spirit of the above statement may not restrict to be rectangle.

The scanning unit 20 is connected to the printing unit 10. (They can be connected using wire or wireless for signal transmissions). The predefined test pattern printed by the printing unit 10 sends manually or mechanically to the scanning unit 20 for scanning. During the scanning process, an indicator 90 in the predefined test pattern has to align with a predetermined reference point in the scanning unit 20 in order to establish the related position between the blocks in the predefined test pattern and the nozzles 111. An image of the predefined test pattern is generated after the scanning. The scanning unit 20 is an optical scanner.

The image data of the predefined test pattern are stored in the memory unit 30 and sent to the analyzing unit 40. The analyzing unit analyzes the image data to determine whether an individual nozzle 111 is damaged or clogged.

When a nozzle 111 is out of order or clogged, it cannot eject ink. The corresponding block in the image is then blank. Thus, the analyzing strategy of the analyzing unit 40 is to check whether any printing block 60 in the image is blank. The analyzing unit 40 has a microprocessor, a signal processor, or a circuit.

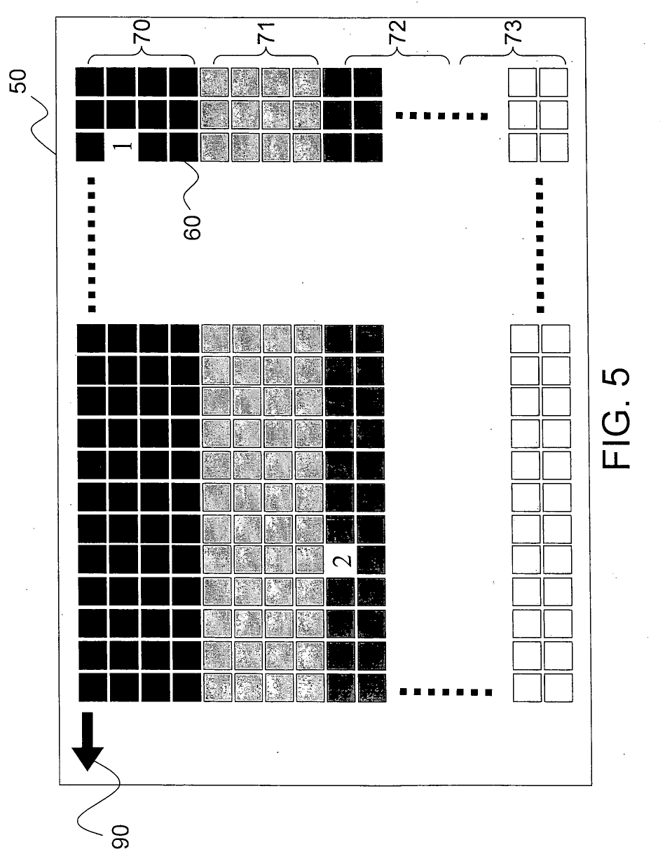

We use the predefined color test pattern shown in FIG. 4 as an example to explain the invention. If some inkjet component 11 prints and scans to render an image of the predefined test pattern as in FIG. 5. The blank blocks marked “1” and “2” represent some black nozzle 11 and some magenta nozzle 111 corresponding to the positions are clogged or out of order. Therefore, these blocks 60 are left blank.

Once all blocks are checked, the analyzing module 40 establishes a mask that lists all faulty nozzles 111 and returns the result to the printing unit 10. Therefore, the mask can be employed to make normal nozzles compensate for the faulty nozzles. The invention is thus able to avoid printing documents with bandings, thereby increasing the quality of printing.

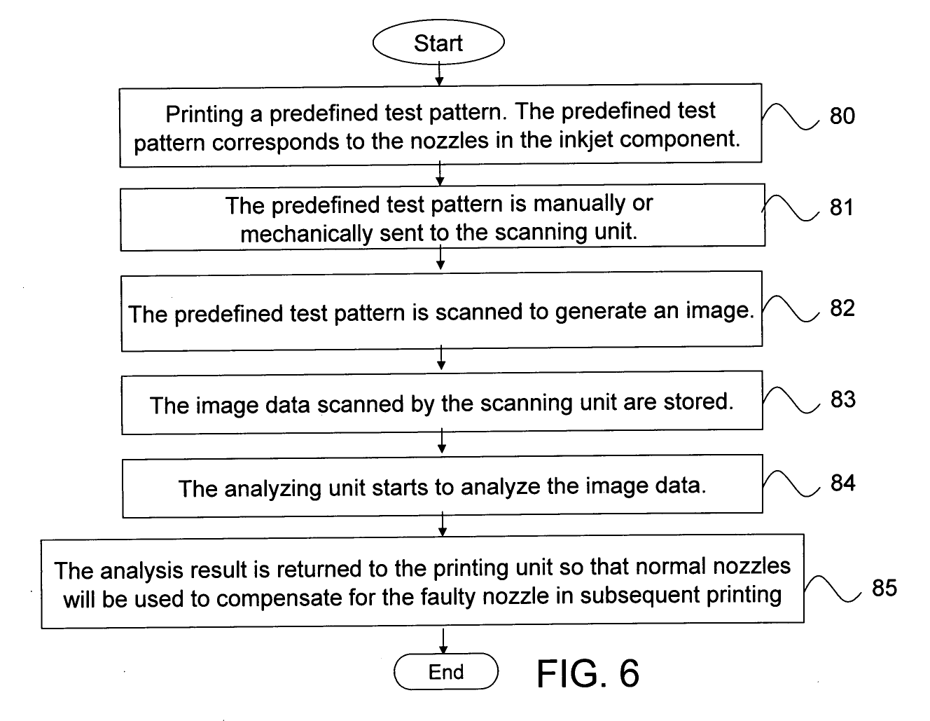

Please refer to FIG. 6 for a flowchart of the disclosed method and, at the same time, to FIG. 1 for the system structure mentioned in the following description. First, a predefined test pattern is printed. The predefined test pattern corresponds to the nozzles in the ink-jet component (step 80). The printing unit 10 first prints a monochromatic or color test pattern as shown in FIG. 3 or FIG. 4. The block 60 in the predefined test pattern corresponds to a distinct nozzle 111. The predefined test pattern sends manually or mechanically to the scanning unit 20 (step 81). The scanning unit 20 then scans the predefined test pattern to generate the image (step 82). The image data scanned by the scanning unit 20 are stored (step 83) in the memory unit. Afterwards, the analyzing unit 40 starts to analyze the image data (step 84). If some block 60 in the image is blank, the corresponding nozzle 111 is determined to be unable to function normally. It may be out of order or clogged.

Finally, the analysis results are returned to the printing unit so that the faulty nozzles will be compensate by using normal nozzles in subsequent printing to increase the equality (step 85). The analyzing module 40 establishes a mask corresponding to the faulty nozzles in accordance with the analysis result and sends it back to the printing unit. Therefore, the mask is employed to make normal nozzles 111 compensate for the faulty nozzles 111. The bandings can thus be avoided.

Certain variations would be apparent to those skilled in the art, which variations are considered within the spirit and scope of the claimed invention.

1. An apparatus for detecting faulty nozzles comprising:
a printing unit, which contains an inkjet component with a plurality of nozzles for printing a predefined test pattern consisted of a plurality of blocks, each of which corresponds to each one of the nozzle;
a scanning unit, which scans the predefined test pattern to generate an image thereof;
an analyzing unit, which analyzes the image of the predefined test pattern to determine the locations of faulty nozzles and returns the result to the printing unit so that normal nozzles are used to compensate for the faulty nozzles in subsequent printing.

2. The apparatus of claim 1 further comprising a memory unit, which stores the image of the predefined test pattern scanned by the scanning unit and sends the image to the analyzing unit for the analyzing unit to determine which nozzle is faulty.

3. The apparatus of claim 1, wherein the scanning unit is an optical scanner.

4. The apparatus of claim 1, wherein the analyzing unit contains a microprocessor.

5. The apparatus of claim 1, wherein the analyzing unit establishes a mask containing all of the faulty nozzles and returns the mask to the printing unit so that normal nozzles are used to compensate for the faulty nozzles in subsequent printing.

6. A method for detecting faulty nozzles used in a scanning unit and a connected printing unit with an inkjet component with more than one nozzle, the method comprising the steps of:
printing a predefined test pattern corresponding to the nozzles on the ink-jet component;
sending the predefined test pattern to the scanning unit;
scanning the predefined test pattern to generate an image thereof;
analyzing the image of the predefined test pattern; and
returning the analysis result to the printing unit so that the normal nozzles are used to compensate for the faulty nozzles in subsequent printing.

7. The method of claim 6, wherein the step of printing a predefined test pattern corresponding to the nozzles on the inkjet component prints the predefined test pattern using the printing unit.

8. The method of claim 6, wherein the step of scanning the predefined test pattern to generate an image thereof scans the predefined test pattern using the scanning unit.

9. The method of claim 6, wherein the step of scanning the predefined test pattern to generate an image thereof is followed by the step of storing the image of the predefined test pattern.

10. The method of claim 6, wherein the step of analyzing the predefined test pattern determines the faulty nozzles from the blank blocks in the predefined test pattern.
